(19) United States
(12) Patent Application Publication
(10) Pub. No.: US 2023/0195634 A1
(43) Pub. Date: Jun. 22, 2023

(54) PREFETCHER WITH LOW-LEVEL SOFTWARE CONFIGURABILITY

(71) Applicant: Intel Corporation, Santa Clara, CA (US)

(72) Inventors: Krishna Ganapathy, Bee Cave, TX (US); Kameswar Subramaniam, Austin, TX (US); Christopher D Bryant, Austin, TX (US); Taylor Morrow, Yorba Linda, CA (US)

(73) Assignee: Intel Corporation, Santa Clara, CA (US)

(21) Appl. No.: 17/553,476

(22) Filed: Dec. 16, 2021

(51) Int. Cl. G06F 12/0862; G06F 12/0831; G06F 9/30; G06F 13/16

(52) U.S. Cl. CPC G06F 12/0862; G06F 12/0833; G06F 9/30101; G06F 13/161; G06F 13/1689

(57) ABSTRACT

An embodiment of an integrated circuit may comprise a prefetcher, a model specific register that is accessible at runtime to store information associated with the prefetcher, and circuitry communicatively coupled to the model specific register and prefetcher to adjust a runtime operation of the prefetcher based on the information associated with the prefetcher stored in the model specific register. Other embodiments are disclosed and claimed.

### BACKGROUND

### 1. Technical Field

This disclosure generally relates to processor technology, and prefetcher technology.

### 2. Background Art

In reference to computer technology, prefetching generally relates to techniques that begin a fetch operation for information that is expected to be needed in the future but before the information is known to be needed. With a prefetch operation, there is generally a risk that the information is not used and the time/resources utilized by the prefetch operation is wasted. Cache prefetching refers to fetching instructions or data from a current memory location to a faster local memory before the instructions/data is actually needed. A computer processor generally includes fast and local cache memory in which prefetched data is held until the data is required or discarded. Some processors include hardware prefetchers that prefetch data and instructions that are likely to be required in the near future from main memory into a level 2 (L2) cache. Ideally, the hardware prefetchers reduce the latency associated with memory reads.

### BRIEF DESCRIPTION OF THE DRAWINGS

The various embodiments of the present invention are illustrated by way of example, and not by way of limitation, in the figures of the accompanying drawings and in which:

FIG. 1 is a block diagram of an example of an integrated circuit according to an embodiment;

FIGS. 2A to 2B are flow diagrams of an example of a method according to an embodiment;

FIG. 3 is a block diagram of an example of an apparatus according to an embodiment;

FIG. 4 is a block diagram of an example of an out-of-order processor according to an embodiment;

FIG. 5A is a block diagram illustrating both an exemplary in-order pipeline and an exemplary register renaming, out-of-order issue/execution pipeline according to embodiments of the invention;

FIG. 5B is a block diagram illustrating both an exemplary embodiment of an in-order architecture core and an exemplary register renaming, out-of-order issue/execution architecture core to be included in a processor according to embodiments of the invention;

FIGS. 6A-B illustrate a block diagram of a more specific exemplary in-order core architecture, which core would be one of several logic blocks (including other cores of the same type and/or different types) in a chip;

FIG. 7 is a block diagram of a processor that may have more than one core, may have an integrated memory controller, and may have integrated graphics according to embodiments of the invention;

FIGS. 8-11 are block diagrams of exemplary computer architectures; and

FIG. 12 is a block diagram contrasting the use of a software instruction converter to convert binary instructions in a source instruction set to binary instructions in a target instruction set according to embodiments of the invention.

### DETAILED DESCRIPTION

Embodiments discussed herein variously provide techniques and mechanisms for runtime prefetcher tuning. The technologies described herein may be implemented in one or more electronic devices. Non-limiting examples of electronic devices that may utilize the technologies described herein include any kind of mobile device and/or stationary device, such as cameras, cell phones, computer terminals, desktop computers, electronic readers, facsimile machines, kiosks, laptop computers, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. More generally, the technologies described herein may be employed in any of a variety of electronic devices including integrated circuitry which is operable to modify behavior of a prefetcher at runtime.

In the following description, numerous details are discussed to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Some embodiments provide technology for low-level software configurability of prefetcher training, throttling, disabling, filtering, and threshold controls. A conventional processor may implement various kinds of prefetchers to improve performance. These prefetchers anticipate needed code or data lines in various structures such as caches, and speculatively fill the code/data into those structures. Accordingly, when a demand request is issued, the code/data is already available in a nearby structure. However, because prefetchers are inherently speculative, some prefetchers may become too aggressive, bringing in lines that are not needed, or bringing the lines in too early such that the lines are evicted before the lines are used. Prefetch that is too aggressive may result in unnecessary memory, mesh, internal bandwidth consumption, etc. that may end up reducing the performance of some workloads.

Each prefetcher is typically based on a different heuristic to target different workloads. Accordingly, each prefetcher typically contains numerous controls to modulate the prefetcher's bandwidth and aggressiveness, and how the prefetcher is initiated, throttled, and tuned. A prefetcher's control information may be initially programmed with data from pre-silicon trace-based analysis and may also be programmed again with data from post-silicon workload-based analysis. Conventionally, the final values for the prefetchers' control information are written into internal control registers that affect the behavior of each prefetcher. A problem is that the internal control registers are not accessible at runtime and cannot be re-configured at runtime. The tuning information is programmed statically for a shipped processor. Typically, only a few different configurations of the prefetcher tuning may be available in different versions of processors that target specific products for specific workloads. Any tuning based on pre-silicon and/or post-silicon data may be based on average behavior of the prefetchers across many workloads and average behavior of platform configurations. These averages may be non-optimal for a specific workload, but conventionally cannot be changed at runtime based on a deployment of a specific application on the processor(s). Some embodiments overcome one or more of the foregoing problems.

In some embodiments, one or more model specific registers (MSRs) are utilized to support low-level software tuning of various prefetchers. The MSRs allow software at a designated privilege level or lower (e.g., software at a more trusted privilege level than the designated privileged level) control over both training and throttling of prefetchers, dynamically disabling specific prefetchers, confidence levels for recursive prefetching, fine grained differentiation of code prefetching over data, control page miss prefetching based on code or data, filtering duplicate prefetches, etc. In some embodiments, low-level software at the designated privilege level(s) may also get control over internal queue thresholds for various prefetchers and relative control over prefetchers for different levels of cache. Different prefetch tuning MSRs may have different designated privilege levels, but the designated level may generally correspond to a most trusted privilege level (e.g., low-level software such as ring zero software or current privilege level zero (CPL0) software).

Advantageously, embodiments may allow low-level software control over a wide variety of parameters, each of which can greatly affect the performance of a specific workload. For example, embodiments allow users to tune more specifically for the user's workloads and the user's specific platform configuration, even at runtime. Depending on the exact workload that is run on a specific core, a suitably configured virtual machine monitor (VMM), operating system (OS), or other software agent with appropriate privilege may first setup embodiments of the prefetcher controls to be better, or most optimal, for that exact workload. Embodiments may also advantageously allow for late binding, or even on the fly tuning, of the prefetchers controls inside the user's environment.

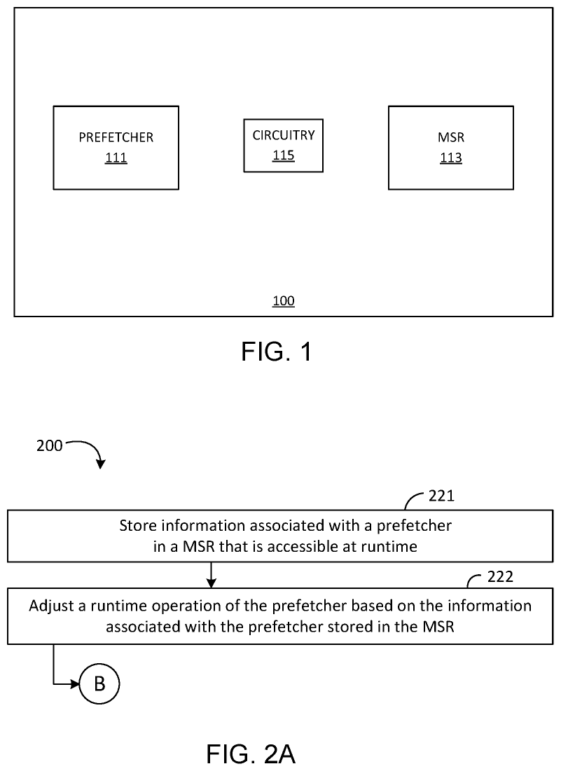

With reference to FIG. 1, an embodiment of an integrated circuit 100 may include a prefetcher 111, a model specific register (MSR) 113 that is accessible at runtime to store information associated with the prefetcher 111, and circuitry 115 communicatively coupled to the MSR 113 and prefetcher 111 to adjust a runtime operation of the prefetcher 111 based on the information associated with the prefetcher 111 stored in the MSR 113. Although shown as separate elements, in some embodiments the circuitry 115 may be incorporated in the prefetcher 111. In some embodiments, the circuitry 115 may be configured to limit access of the MSR 113 to software with a most trusted privilege level (e.g., CPL0). In some embodiments, the circuitry 115 may be further configured to adjust how the prefetcher 111 is trained at runtime based on the information associated with the prefetcher 111 stored in the MSR 113, to adjust a throttle of the prefetcher 111 at runtime based on the information associated with the prefetcher 111 stored in the MSR 113, and/or to adjust a filter of the prefetcher 111 at runtime based on the information associated with the prefetcher 111 stored in the MSR 113. Additionally, or alternatively, the circuitry 115 may be further configured to adjust a threshold of the prefetcher 111 at runtime based on the information associated with the prefetcher 111 stored in the MSR 113. For example, the circuitry 115 may be configured to adjust an internal queue threshold of the prefetcher 111 at runtime based on the information associated with the prefetcher 111 stored in the MSR 113.

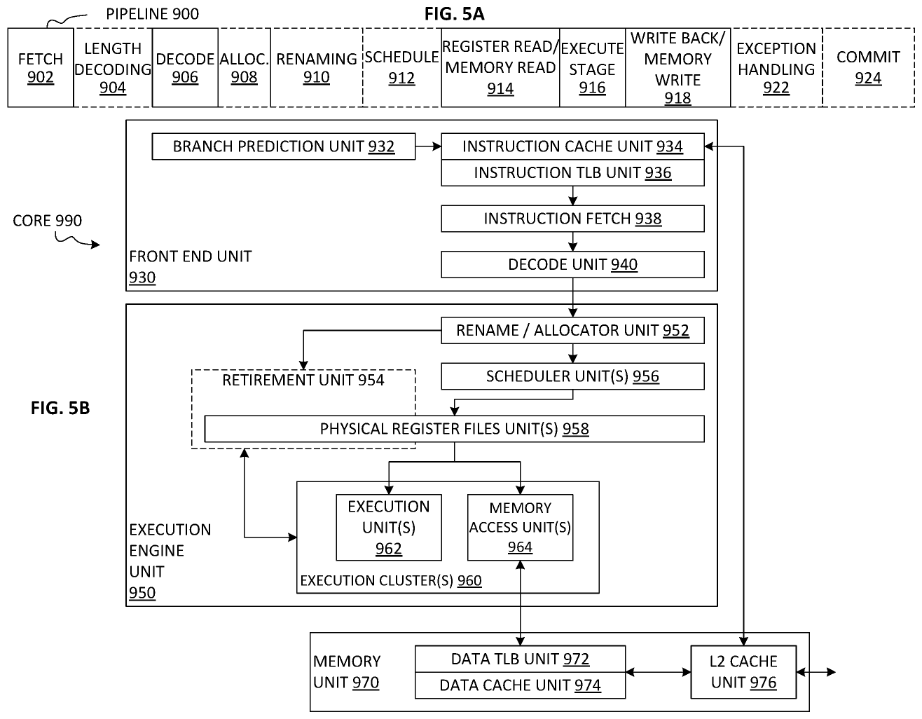

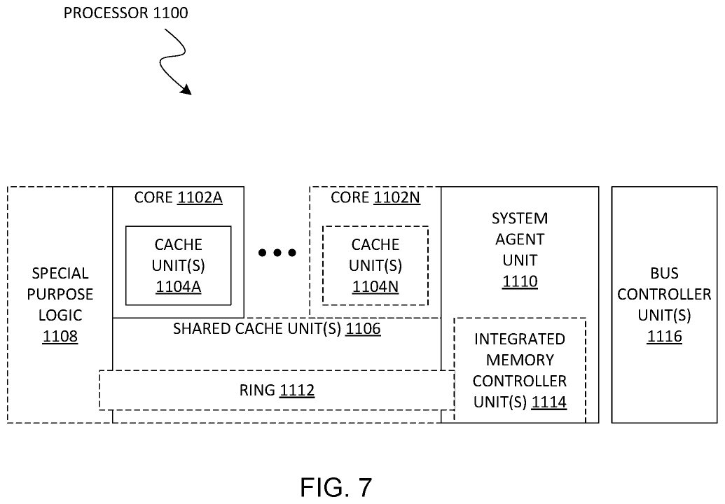

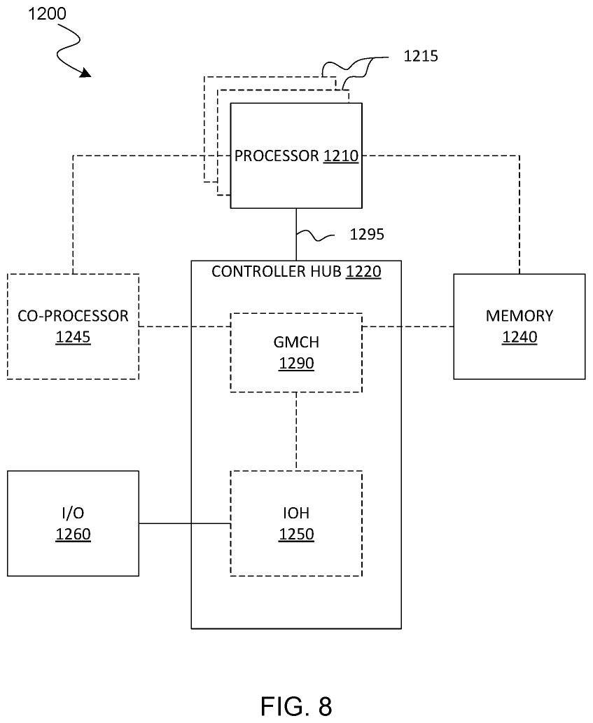

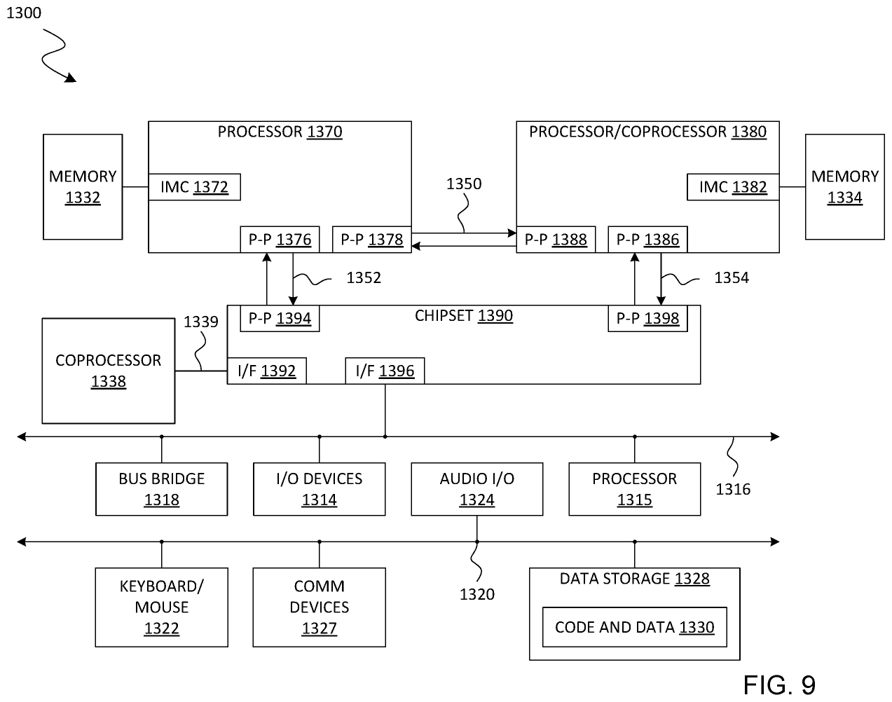

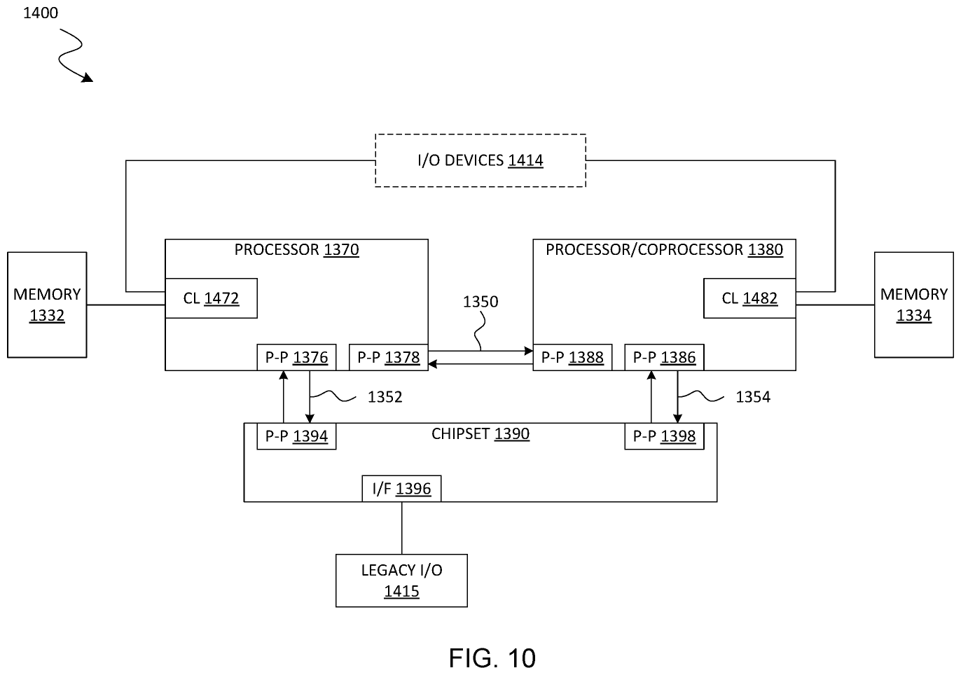

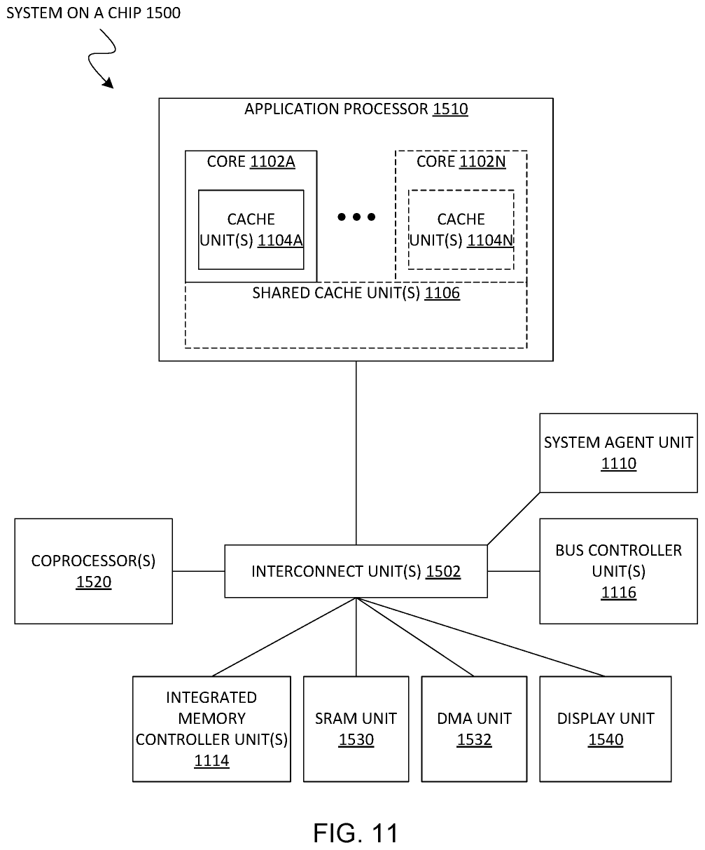

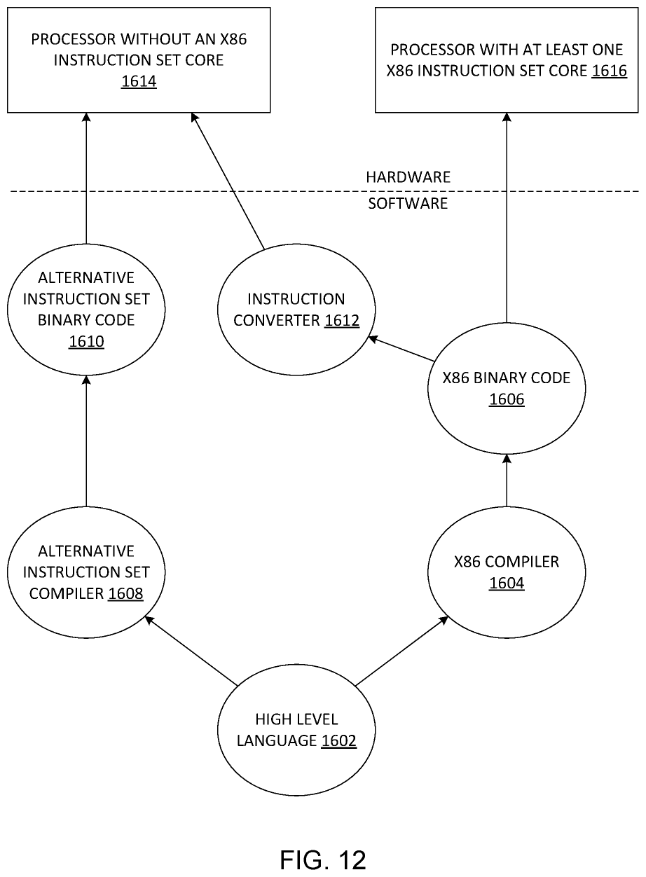

Embodiments of the prefetcher 111, the MSR 113, and/or the circuitry 115 may be incorporated in a processor including, for example, the core 990 (FIG. 5B), the cores 1102A-N (FIGS. 7, 11), the processor 1210 (FIG. 8), the co-processor 1245 (FIG. 8), the processor 1370 (FIGS. 9-10), the processor/coprocessor 1380 (FIGS. 9-10), the coprocessor 1338 (FIGS. 9-10), the coprocessor 1520 (FIG. 11), and/or the processors 1614, 1616 (FIG. 12).

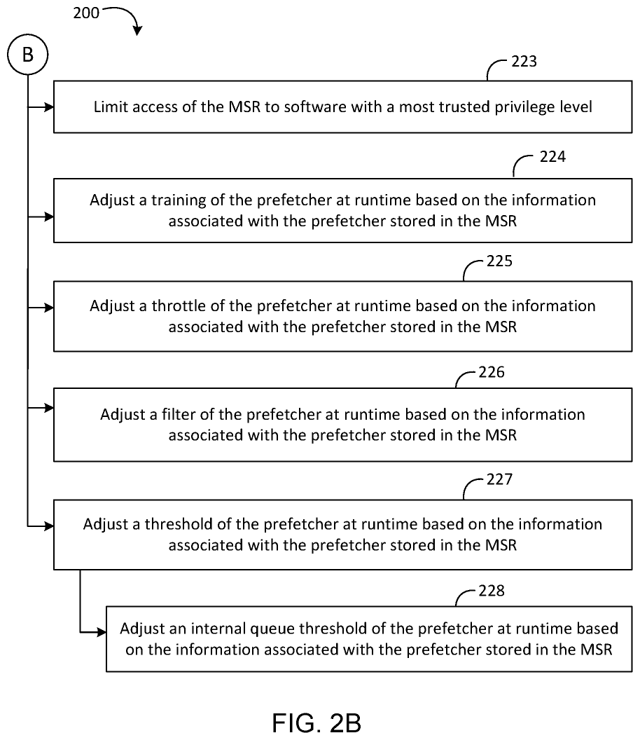

With reference to FIGS. 2A to 2B, although an embodiment of a method 200 is illustrated in the form of a flow diagram, the various aspects described in the illustrated boxes are not necessarily performed in any particular order (unless otherwise specified) and some boxes describe further qualifiers of prior aspects and not additional aspects. Embodiments of the method 200 may include storing information associated with a prefetcher in a MSR that is accessible at runtime at box 221, and adjusting a runtime operation of the prefetcher based on the information associated with the prefetcher stored in the MSR at box 222. Some embodiments of the method 200 further include limiting access of the MSR to software with a most trusted privilege level at box 223. The method 200 may also include adjusting a training of the prefetcher at runtime based on the information associated with the prefetcher stored in the MSR at box 224, adjusting a throttle of the prefetcher at runtime based on the information associated with the prefetcher stored in the MSR at box 225, and/or adjusting a filter of the prefetcher at runtime based on the information associated with the prefetcher stored in the MSR at box 226. Additionally, or alternatively, the method 200 may further include adjusting a threshold of the prefetcher at runtime based on the information associated with the prefetcher stored in the MSR at box 227. For example, the method 20 may include adjusting an internal queue threshold of the prefetcher at runtime based on the information associated with the prefetcher stored in the MSR at box 228.

Embodiments of the method 200 may be performed by a processor including, for example, the core 990 (FIG. 5B), the cores 1102A-N (FIGS. 7, 11), the processor 1210 (FIG. 8), the co-processor 1245 (FIG. 8), the processor 1370 (FIGS. 9-10), the processor/coprocessor 1380 (FIGS. 9-10), the coprocessor 1338 (FIGS. 9-10), the coprocessor 1520 (FIG. 11), and/or the processors 1614, 1616 (FIG. 12).

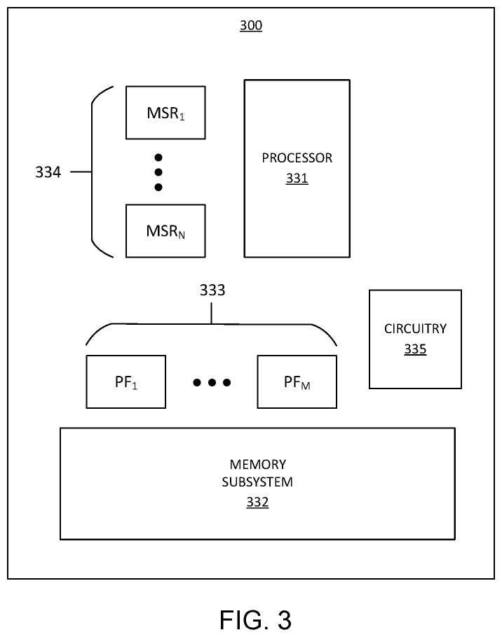

With reference to FIG. 3, an embodiment of an apparatus 300 may include a processor 331, a memory subsystem 332 coupled to the processor 331, two or more prefetchers 333 (e.g., PF₁ through PF_{M}; where M>1) coupled to the memory subsystem 332, two or more MSRs 334 (e.g., MSR₁ through MSR_{N}; where N>1 and N is not necessarily the same as M) to respectively store information associated with the two or more prefetchers 333, and circuitry 335 communicatively coupled to the two or more MSRs 334 and the two or more prefetchers 333 to adjust an operation of the two or more prefetchers 333 based on the information stored in the two or more MSRs 334. In some embodiments, the circuitry 335 may be configured to limit access of the two or more MSRs 334 to software with a most trusted privilege level (e.g., CPL0). In some embodiments, the circuitry 335 may be further configured to adjust how one or more prefetchers of the two or more prefetchers 333 is trained at runtime based on information associated with the one or more prefetchers stored in the two or more MSRs 334, to adjust a throttle of one or more prefetchers of the two or more prefetchers 333 at runtime based on information associated with the one or more prefetchers stored in the two or more MSRs 334, and/to adjust a filter of one or more prefetchers of the two or more prefetchers 333 at runtime based on information associated with the one or more prefetchers stored in the two or more MSRs 334. Additionally, or alternatively, the circuitry 335 may be further configured to adjust a threshold of one or more prefetchers of the two or more prefetchers 333 at runtime based on information associated with the one or more prefetchers stored in the two or more MSRs 334. For example, the circuitry 335 may be configured to adjust an internal queue threshold of one or more prefetchers of the two or more prefetchers 333 at runtime based on information associated with the one or more prefetchers stored in the two or more MSRs 334.

Embodiments of the memory subsystem 332, the two or more prefetchers 333, the two or more MSRs 334, and/or the circuitry 335 may be incorporated in or integrated with a processor including, for example, the core 990 (FIG. 5B), the cores 1102A-N (FIGS. 7, 11), the processor 1210 (FIG. 8), the co-processor 1245 (FIG. 8), the processor 1370 (FIGS. 9-10), the processor/coprocessor 1380 (FIGS. 9-10), the coprocessor 1338 (FIGS. 9-10), the coprocessor 1520 (FIG. 11), and/or the processors 1614, 1616 (FIG. 12).

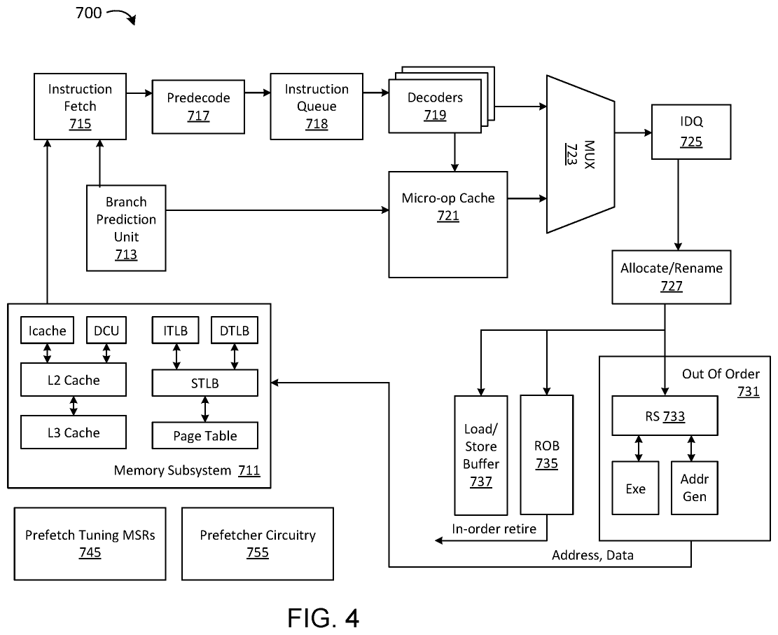

With reference to FIG. 4, an embodiment of an out-of-order (000) processor 700 includes a memory subsystem 711, a branch prediction unit 713, an instruction fetch circuit 715, a predecode circuit 717, an instruction queue 718, decoders 719, a micro-op cache 721, a mux 723, an instruction decode queue (IDQ) 725, an allocate/rename circuit 727, an out-of-order core 731, a reservation station (RS) 733, a re-order buffer (ROB) 735, and a load/store buffer 737, connected as shown. The memory subsystem 711 include a L1 instruction cache (I-cache), a L1 data cache (DCU), a L2 cache, a L3 cache, an ITLB, a data translation lookaside buffer (DTLB), a shared translation lookaside buffer (STLB), and a page table, connected as shown. The 000 core 731 includes a reservation station (RS), an Exe circuit, and an address generation circuit, connected as shown. The OOO processor 700 further includes prefetch tuning MSRs 745, prefetcher circuitry 755, and other circuitry, to enable runtime prefetch tuning for the OOO processor 700. Although shown as a separate block, the prefetcher circuitry 755 may be distributed throughout various components of the OOO processor 700 including, for example, memory subsystem 711, the branch prediction unit 713, the instruction fetch circuit 715, the predecode circuit 717, the instruction queue 718, the decoders 719, the mux 723, etc.

The prefetch tuning MSRs 745 and the prefetcher circuitry 755 may be configured to implement one or more aspects of the embodiments described herein. The prefetch tuning MSRs 745 store a plurality of prefetcher control fields that correlate to specific aspects of the prefetcher circuitry 755 (e.g., specific configurable prefetchers, specific prefetch algorithms, specific prefetch structures used by the configurable prefetchers, etc.). In general, details of the various configurable prefetchers supported by the processor 700 including how the configurable prefetchers work, what aspects of the configurable prefetchers are configurable, the control fields of the prefetch tuning MSRs, etc., are made available to the users (e.g., through suitable documentation) such that the user can tune the configurable prefetchers to better suit the user's workload(s). Various VMM, hypervisor, OS, or other software drivers may also be configured to support the prefetch tuning MSRs 745.

For example, the prefetcher circuitry 755 may include two or more prefetchers that anticipate needed code or data lines in various structures (e.g., the I-cache, the L2 cache, etc.), and speculatively fill the code/data lines into those structures. The prefetch tuning MSRs 745 allow CPL0 software to control various prefetcher parameters. The prefetcher circuitry 755 is configured to adjust the behavior of the two or more prefetchers based on the control fields stored in the prefetch tuning MSRs 745.

Example parameters listed below provide suitably privileged low-level software (e.g., CPL0) control over prefetcher behavior that can beneficially affect the performance of a specific workload. Depending on the exact workload that is run on a specific core, the VMM or OS can first store appropriate values in the prefetch tuning MSRs 745 that setup the prefetcher controls to be better or optimal for that workload. The accessibility of the prefetch tuning MSRs 745 allows users to tune more or most specifically for the user's workloads and the user's specific platform configuration. In some embodiments, the prefetcher circuitry 755 may be configured to allow for late binding, or even on the fly tuning, of the prefetchers controls inside the user's environment based on values written to the control fields of the prefetch tuning MSRs 745. Given the benefit of the present application, numerous examples of the utilization of a field in a MSR to control/modify the behavior of a prefetcher will occur to those skilled in the art. The following examples should be considered as illustrative and non-limiting.

### Examples of MSR Fields to Control Second Level Cache Prefetcher Training

The second Level Cache (L2) prefetchers may be trained in hardware by analyzing the demand request pattern. There are different types of demand requests with unique characteristics for the different types of demand request, such as data read, request for ownership, code read, first level (L1) prefetches, software prefetches, etc. For each request type, embodiments of prefetcher tuning technology allow privileged software to control whether the L2 prefetcher is trained or not on different types of demand requests. For example, one set of MSR fields may determine if a new L2 prefetch stream is created on the different types of demand requests, and another set of MSR fields may determine if existing L2 prefetch streams are further trained by the different types of demand requests. For example, privileged software can choose not to train the L2 prefetcher on code accesses if the code has a small footprint and dedicate all the prefetcher resources for data prefetching. Some embodiments may provide another set of MSR fields to control how the L2 streamer prefetcher behaves after a stream is created, including a number of prefetches to generate on a trigger and a size of the trigger window.

### Examples of MSR Fields To Control Prefetcher Dynamic Disabling

Depending on the data access pattern, prefetching may be ineffective at times. On bandwidth constrained systems, it may even hurt overall performance if prefetched data is not used by demand requests. Some embodiments may provide one or more MSR fields to control turn on/off of prefetching at different levels. For example, another MSR field may be set/cleared to enable/disable a next line prefetcher, that fetches the next cache line based on the current demand request when enabled. In another example, another MSR field may be set/cleared to by privileged software to enable/disable all L2 prefetchers. For example, disabling all of the L2 prefetchers may be beneficial if the privileged software determines that the data access pattern is completely random (e.g., such as while running pointer chasing algorithms). In another example. another MSR field may be set/cleared to turn on/off just an adaptive pattern prefetcher unconditionally or based on the workload exhibiting a sequential access pattern. In the latter case, the embodiments of the prefetcher circuitry 755 (e.g., or other hardware) may detect when the accesses are sequential and automatically clears the appropriate MSR field to turn off the pattern prefetcher to dedicate all resources to the stream prefetcher.

### Examples of MSR Fields to Control Recursive Prefetching

An adaptive pattern prefetcher may be capable of recursively prefetching deep into the access stream based on a programmable confidence level. In some embodiments, the aggressiveness of the prefetcher may be controlled through one or more MSR fields for respective confidence levels that correspond to various levels of overall system bandwidth available. For example, privileged software may store suitable values in the MSR confidence level fields to program monotonically increasing thresholds (e.g., a proxy for confidence) for decreasing levels of system bandwidth availability. In some embodiments, support may be provided for four levels of confidence based on the system bandwidth available. In another example, another MSR field may be set/cleared to turn the recursion on/off.

### Examples of MSR Fields to Control Code Prefetching

An L2 prefetcher may utilize different algorithms for code prefetching based on code stream characteristics. In some embodiments, the characteristics of the code prefetcher may be controlled through one or more MSR fields to turn the feature completely off, to set how many prefetches to generate on accesses to a beginning of a page, to set how many prefetches to generate on accesses to an end of a page, to set how many prefetches to generate on accesses to somewhere in the middle of a page, etc. Because code streams behave differently from data streams, these MSR fields provide flexibility for privileged software to control the two streams independently.

### Examples of MSR Fields to Control Page Miss Prefetch

When generating prefetches for page table walks, prefetches may be generated using either the data prefetching or the code prefetching algorithm implemented in hardware. Depending on the page walk pattern, embodiments enable privileged software to choose between either the data prefetching or the code prefetching algorithm based on a value/state of a single MSR field.

### Examples of MSR Fields to Control Duplicate Prefetch Filtering

Because there may be different types of prefetchers working in conjunction at the L2 level at the same time, it is possible for prefetchers to generate duplicate prefetches to the same address. Accordingly, some processors may include a mechanism to filter prefetches to the same address within a page boundary (e.g., a four kilobyte (4K) page boundary) to save bandwidth. However, it is possible for older prefetches to get dropped for various reasons. To send prefetches to the same address that have already been sent, some embodiments provide another MSR field to enable/disable a duplicate prefetch filter. Depending on the available system bandwidth and the usefulness of the prefetches, for example, privileged software may opt to store an appropriate value in the MSR field to disable the duplicate prefetch filter to gain more performance.

### Examples of MSR Fields to Control Internal Queue Thresholds for Prefetching

With multiple cores within a same module, internal queue structures may be shared among the cores for issuing both demand requests and prefetch requests. Some embodiments may provide a set of MSR fields as privileged software programmable queue threshold controls for an L2 look-up queue as well as an L2 miss queue. The respective values stored in the set of MSR fields for the respective internal queue thresholds may specify watermark levels beyond which the prefetches are stopped temporarily from being issued. In addition, to prevent a single core from overrunning the system with prefetches, some embodiments include another MSR field as a separate queue threshold to control prefetches when only one core is active in the module. The separate queue threshold is utilized when a single core issued prefetches do not surpass a programmable usefulness counter threshold.

### Examples of MSR Fields to Control a Prefetch Internal Throttler

A stream prefetcher in the L2 cache may be operating on multiple 4K pages at the same time. The usefulness of the various prefetch streams may be measured dynamically both individually as well as collectively across all the streams. In some embodiments, privileged software may set usefulness count thresholds in a set of MSR fields to control both individual streams as well as the overall prefetcher. Another MSR field may provide a privileged software programmable global throttle threshold that must be exceeded by the sum of useful prefetches across all active streams for the prefetcher to be kept active. Some embodiments may also include another MSR field to provide a privileged software programmable local throttle threshold to override the global throttle threshold and keep a particular stream alive if that stream sends out prefetches that exceed the local throttle threshold. The throttler may reference separate MSR fields to determine if the stream prefetcher should kickstart prefetching based on a demand request accessing the beginning or the end of a 4K page. For example, if the prefetcher overall is doing a poor job fetching useful lines, storing an appropriate value in the separate MSR fields may help curtail the number of prefetches until the prefetcher performance improves as measured by the throttler.

### Examples of MSR Fields to Control a Last Level Cache (LLC) Prefetcher

Prefetcher logic may generate prefetches that only fill into the LLC in some systems. These prefetches usually prefetch sufficiently ahead of the L2 prefetcher so that the L2 prefetches can hit in the LLC. In addition to an overall MSR control over the LLC prefetcher, some embodiments may provide a set of MSR fields to control the aggressiveness of the LLC prefetches if LLC prefetches are enabled. For example, the set of MSR fields may control how far ahead of the L2 prefetches the LLC prefetches go and a minimum distance between the LLC prefetches. The set of MSR fields may also specify a number of LLC prefetches to create for each trigger and a maximum number of LLC prefetches that can be pending at a time. The set of MSR fields may also provide a separate control over whether the LLC prefetches look-up the L2 cache and get dropped if the LLC prefetch hits the L2 cache, thereby saving redundant prefetching.

### Examples of MSR Fields to Control a Last Level Cache (LLC) Prefetch Throttler

Because the LLC prefetches may be more speculative, LLC prefetches may be controlled using LLC prefetch-specific throttling logic. For example, the LLC prefetch throttler may kick in to disable LLC prefetching when a significant number of LLC prefetches hit in the LLC (e.g., signifying redundant prefetches). After the LLC prefetches are turned off, the LLC prefetcher may only be turned back on when a sufficient number of L2 prefetches start missing in the LLC (e.g., signifying the need for LLC prefetches). In some embodiments, the throttling and un-throttling functions in the hardware may be programmable from values stored in MSR fields to determine how quickly the LLC prefetches turn off or turn back on.

### Examples of MSR Fields to Control Homeless Prefetch Throttle

Homeless prefetch may refer to a prefetch that brings data into the L2 cache only. For example, prefetches of medium cache types (e.g., T1=L2+L3 caches) or far cache types (e.g., T2=L3 cache only) may involve homeless prefetch. The core may have very active prefetchers that sometime are so far ahead of the demand loads of the program these prefetchers dilute the cache data. Making the prefetchers bring data only into the L2 cache saves the latency of going to the LLC or to dynamic random access memory (DRAM). However, because these active prefetchers can cause a lot of external traffic the program sometimes would like to slow down the number of these prefetch requests. In some embodiments, the throttling and un-throttling functions in the hardware may be programmable from values stored in MSR fields that will cease these requests if the core is actively hitting within the L2 cache (e.g., preventing or reducing dilution of either the L1 or the L2 cache from overactive prefetchers).

Those skilled in the art will appreciate that a wide variety of devices may benefit from the foregoing embodiments. The following exemplary core architectures, processors, and computer architectures are non-limiting examples of devices that may beneficially incorporate embodiments of the technology described herein.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

### Exemplary Core Architectures

In-Order and Out-of-Order Core Block Diagram

FIG. 5A is a block diagram illustrating both an exemplary in-order pipeline and an exemplary register renaming, out-of-order issue/execution pipeline according to embodiments of the invention. FIG. 5B is a block diagram illustrating both an exemplary embodiment of an in-order architecture core and an exemplary register renaming, out-of-order issue/execution architecture core to be included in a processor according to embodiments of the invention. The solid lined boxes in FIGS. 5A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 5A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 5B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

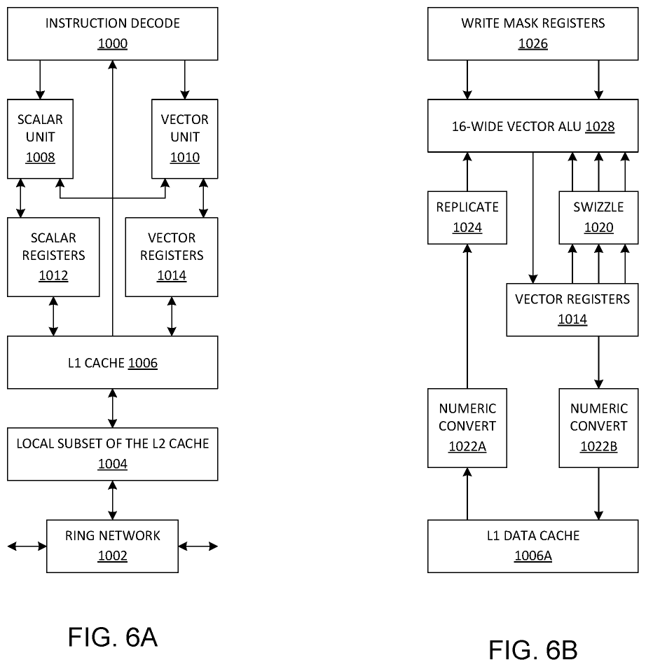

FIGS. 6A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 6A is a block diagram of a single processor core, along with its connection to the on-die interconnect network 1002 and with its local subset of the Level 2 (L2) cache 1004, according to embodiments of the invention. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The local subset of the L2 cache 1004 is part of a global L2 cache that is divided into separate local subsets, one per processor core. Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 6B is an expanded view of part of the processor core in FIG. 6A according to embodiments of the invention. FIG. 6B includes an L1 data cache 1006A part of the L1 cache 1006, as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

FIG. 7 is a block diagram of a processor 1100 that may have more than one core, may have an integrated memory controller, and may have integrated graphics according to embodiments of the invention. The solid lined boxes in FIG. 7 illustrate a processor 1100 with a single core 1102A, a system agent 1110, a set of one or more bus controller units 1116, while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1100 may be a part of and/or may be implemented on one or more substrates using any of a number of process technologies, such as, for example, BiCMOS, CMOS, or NMOS.

The memory hierarchy includes one or more levels of respective caches 1104A-N within the cores 1102A-N, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the integrated graphics logic 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102-A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the integrated graphics logic 1108. The display unit is for driving one or more externally connected displays.

The cores 1102A-N may be homogenous or heterogeneous in terms of architecture instruction set; that is, two or more of the cores 1102A-N may be capable of execution the same instruction set, while others may be capable of executing only a subset of that instruction set or a different instruction set.

### Exemplary Computer Architectures

FIGS. 8-11 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 8, shown is a block diagram of a system 1200 in accordance with one embodiment of the present invention. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips); the GMCH 1290 includes memory and graphics controllers to which are coupled memory 1240 and a coprocessor 1245; the IOH 1250 couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 in a single chip with the IOH 1250.

The optional nature of additional processors 1215 is denoted in FIG. 8 with broken lines. Each processor 1210, 1215 may include one or more of the processing cores described herein and may be some version of the processor 1100.

The memory 1240 may be, for example, dynamic random access memory (DRAM), phase change memory (PCM), or a combination of the two. For at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

Referring now to FIG. 9, shown is a block diagram of a first more specific exemplary system 1300 in accordance with an embodiment of the present invention. As shown in FIG. 9, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the invention, processors 1370 and 1380 are respectively processors 1210 and 1215, while coprocessor 1338 is coprocessor 1245. In another embodiment, processors 1370 and 1380 are respectively processor 1210 coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 9, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339 and an interface 1392. In one embodiment, the coprocessor 1338 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 9, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are possible. For example, instead of the point-to-point architecture of FIG. 9, a system may implement a multi-drop bus or other such architecture.

Referring now to FIG. 10, shown is a block diagram of a second more specific exemplary system 1400 in accordance with an embodiment of the present invention Like elements in FIGS. 9 and 10 bear like reference numerals, and certain aspects of FIG. 9 have been omitted from FIG. 10 in order to avoid obscuring other aspects of FIG. 10.

FIG. 10 illustrates that the processors 1370, 1380 may include integrated memory and I/O control logic (“CL”) 1472 and 1482, respectively. Thus, the CL 1472, 1482 include integrated memory controller units and include I/O control logic. FIG. 10 illustrates that not only are the memories 1332, 1334 coupled to the CL 1472, 1482, but also that I/O devices 1414 are also coupled to the control logic 1472, 1482. Legacy I/O devices 1415 are coupled to the chipset 1390.

Referring now to FIG. 11, shown is a block diagram of a SoC 1500 in accordance with an embodiment of the present invention. Similar elements in FIG. 7 bear like reference numerals. Also, dashed lined boxes are optional features on more advanced SoCs. In FIG. 11, an interconnect unit(s) 1502 is coupled to: an application processor 1510 which includes a set of one or more cores 1102A-N and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 9, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

FIG. 12 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 12 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 12 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

Techniques and architectures for runtime prefetcher tuning are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

### Additional Notes and Examples

Example 1 includes an integrated circuit, comprising a prefetcher, a MSR that is accessible at runtime to store information associated with the prefetcher, and circuitry communicatively coupled to the MSR and prefetcher to adjust a runtime operation of the prefetcher based on the information associated with the prefetcher stored in the MSR.

Example 2 includes the integrated circuit of Example 1, wherein the circuitry is further to limit access of the MSR to software with a most trusted privilege level.

Example 3 includes the integrated circuit of any of Examples 1 to 2, wherein the circuitry is further to adjust how the prefetcher is trained at runtime based on the information associated with the prefetcher stored in the MSR.

Example 4 includes the integrated circuit of any of Examples 1 to 3, wherein the circuitry is further to adjust a throttle of the prefetcher at runtime based on the information associated with the prefetcher stored in the MSR.

Example 5 includes the integrated circuit of any of Examples 1 to 4, wherein the circuitry is further to adjust a filter of the prefetcher at runtime based on the information associated with the prefetcher stored in the MSR.

Example 6 includes the integrated circuit of any of Examples 1 to 5, wherein the circuitry is further to adjust a threshold of the prefetcher at runtime based on the information associated with the prefetcher stored in the MSR.

Example 7 includes the integrated circuit of Example 6, wherein the circuitry is further to adjust an internal queue threshold of the prefetcher at runtime based on the information associated with the prefetcher stored in the MSR.

Example 8 includes a method, comprising storing information associated with a prefetcher in a MSR that is accessible at runtime, and adjusting a runtime operation of the prefetcher based on the information associated with the prefetcher stored in the MSR.

Example 9 includes the method of Example 8, further comprising limiting access of the MSR to software with a most trusted privilege level.

Example 10 includes the method of any of Examples 8 to 9, further comprising adjusting a training of the prefetcher at runtime based on the information associated with the prefetcher stored in the MSR.

Example 11 includes the method of any of Examples 8 to 10, further comprising adjusting a throttle of the prefetcher at runtime based on the information associated with the prefetcher stored in the MSR.

Example 12 includes the method of any of Examples 8 to 11, further comprising adjusting a filter of the prefetcher at runtime based on the information associated with the prefetcher stored in the MSR.

Example 13 includes the method of any of Examples 8 to 12, further comprising adjusting a threshold of the prefetcher at runtime based on the information associated with the prefetcher stored in the MSR.

Example 14 includes the method of Example 13, further comprising adjusting an internal queue threshold of the prefetcher at runtime based on the information associated with the prefetcher stored in the MSR.

Example 15 includes an apparatus, comprising a processor, a memory subsystem coupled to the processor, two or more prefetchers coupled to the memory subsystem, two or more MSRs to respectively store information associated with the two or more prefetchers, and circuitry communicatively coupled to the two or more MSRs and the two or more prefetchers to adjust an operation of the two or more prefetchers based on the information stored in the two or more MSRs.

Example 16 includes the apparatus of Example 15, wherein the circuitry is further to limit access of the two or more MSRs to software with a most trusted privilege level.

Example 17 includes the apparatus of any of Examples 15 to 16, wherein the circuitry is further to adjust how one or more prefetchers of the two or more prefetchers is trained at runtime based on information associated with the one or more prefetchers stored in the two or more MSRs.

Example 18 includes the apparatus of any of Examples 15 to 17, wherein the circuitry is further to adjust a throttle of one or more prefetchers of the two or more prefetchers at runtime based on information associated with the one or more prefetchers stored in the two or more MSRs.

Example 19 includes the apparatus of any of Examples 15 to 18, wherein the circuitry is further to adjust a filter of one or more prefetchers of the two or more prefetchers at runtime based on information associated with the one or more prefetchers stored in the two or more MSRs.

Example 20 includes the apparatus of any of Examples 15 to 19, wherein the circuitry is further to adjust a threshold of one or more prefetchers of the two or more prefetchers at runtime based on information associated with the one or more prefetchers stored in the two or more MSRs.

Example 21 includes the apparatus of Example 20, wherein the circuitry is further to adjust an internal queue threshold of one or more prefetchers of the two or more prefetchers at runtime based on information associated with the one or more prefetchers stored in the two or more MSRs.

Example 22 includes an apparatus, comprising means for storing information associated with a prefetcher in a MSR that is accessible at runtime, and means for adjusting a runtime operation of the prefetcher based on the information associated with the prefetcher stored in the MSR.

Example 23 includes the apparatus of Example 22, further comprising means for limiting access of the MSR to software with a most trusted privilege level.

Example 24 includes the apparatus of any of Examples 22 to 23, further comprising means for adjusting a training of the prefetcher at runtime based on the information associated with the prefetcher stored in the MSR.

Example 25 includes the apparatus of any of Examples 22 to 24, further comprising means for adjusting a throttle of the prefetcher at runtime based on the information associated with the prefetcher stored in the MSR.

Example 26 includes the apparatus of any of Examples 22 to 25, further comprising means for adjusting a filter of the prefetcher at runtime based on the information associated with the prefetcher stored in the MSR.

Example 27 includes the apparatus of any of Examples 22 to 26, further comprising means for adjusting a threshold of the prefetcher at runtime based on the information associated with the prefetcher stored in the MSR.

Example 28 includes the apparatus of Example 27, further comprising means for adjusting an internal queue threshold of the prefetcher at runtime based on the information associated with the prefetcher stored in the MSR.

Example 29 includes at least one non-transitory machine readable medium comprising a plurality of instructions that, in response to being executed on a computing device, cause the computing device to store information associated with a prefetcher in a MSR that is accessible at runtime, and adjust a runtime operation of the prefetcher based on the information associated with the prefetcher stored in the MSR.

Example 30 includes the at least one non-transitory machine readable medium of Example 29, comprising a plurality of further instructions that, in response to being executed on the computing device, cause the computing device to limit access of the MSR to software with a most trusted privilege level.

Example 31 includes the at least one non-transitory machine readable medium of any of Examples 29 to 30, comprising a plurality of further instructions that, in response to being executed on the computing device, cause the computing device to adjust how one or more prefetchers of the two or more prefetchers is trained at runtime based on information associated with the one or more prefetchers stored in the two or more MSRs.

Example 32 includes the at least one non-transitory machine readable medium of any of Examples 29 to 31, comprising a plurality of further instructions that, in response to being executed on the computing device, cause the computing device to adjust a throttle of the prefetcher at runtime based on the information associated with the prefetcher stored in the MSR.

Example 33 includes the at least one non-transitory machine readable medium of any of Examples 29 to 32, comprising a plurality of further instructions that, in response to being executed on the computing device, cause the computing device to adjust a filter of the prefetcher at runtime based on the information associated with the prefetcher stored in the MSR.

Example 34 includes the at least one non-transitory machine readable medium of any of Examples 29 to 33, comprising a plurality of further instructions that, in response to being executed on the computing device, cause the computing device to adjust a threshold of the prefetcher at runtime based on the information associated with the prefetcher stored in the MSR.

Example 35 includes the at least one non-transitory machine readable medium of Example 34, comprising a plurality of further instructions that, in response to being executed on the computing device, cause the computing device to adjust an internal queue threshold of the prefetcher at runtime based on the information associated with the prefetcher stored in the MSR.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit, comprising:
a prefetcher;
a model specific register that is accessible at runtime to store information associated with the prefetcher; and
circuitry communicatively coupled to the model specific register and prefetcher to adjust a runtime operation of the prefetcher based on the information associated with the prefetcher stored in the model specific register.

2. The integrated circuit of claim 1, wherein the circuitry is further to:
limit access of the model specific register to software with a most trusted privilege level.

3. The integrated circuit of claim 1, wherein the circuitry is further to:
adjust how the prefetcher is trained at runtime based on the information associated with the prefetcher stored in the model specific register.

4. The integrated circuit of claim 1, wherein the circuitry is further to:
adjust a throttle of the prefetcher at runtime based on the information associated with the prefetcher stored in the model specific register.

5. The integrated circuit of claim 1, wherein the circuitry is further to:
adjust a filter of the prefetcher at runtime based on the information associated with the prefetcher stored in the model specific register.

6. The integrated circuit of claim 1, wherein the circuitry is further to:
adjust a threshold of the prefetcher at runtime based on the information associated with the prefetcher stored in the model specific register.

7. The integrated circuit of claim 6, wherein the circuitry is further to:
adjust an internal queue threshold of the prefetcher at runtime based on the information associated with the prefetcher stored in the model specific register.

8. A method, comprising:
storing information associated with a prefetcher in a model specific register that is accessible at runtime; and
adjusting a runtime operation of the prefetcher based on the information associated with the prefetcher stored in the model specific register.

9. The method of claim 8, further comprising:
limiting access of the model specific register to software with a most trusted privilege level.

10. The method of claim 8, further comprising:
adjusting a training of the prefetcher at runtime based on the information associated with the prefetcher stored in the model specific register.

11. The method of claim 8, further comprising:
adjusting a throttle of the prefetcher at runtime based on the information associated with the prefetcher stored in the model specific register.

12. The method of claim 8, further comprising:
adjusting a filter of the prefetcher at runtime based on the information associated with the prefetcher stored in the model specific register.

13. The method of claim 8, further comprising:
adjusting a threshold of the prefetcher at runtime based on the information associated with the prefetcher stored in the model specific register.

14. The method of claim 13, further comprising:
adjusting an internal queue threshold of the prefetcher at runtime based on the information associated with the prefetcher stored in the model specific register.

15. An apparatus, comprising:
a processor;
a memory subsystem coupled to the processor;
two or more prefetchers coupled to the memory subsystem;
two or more model specific registers to respectively store information associated with the two or more prefetchers; and
circuitry communicatively coupled to the two or more model specific registers and the two or more prefetchers to adjust an operation of the two or more prefetchers based on the information stored in the two or more model specific registers.

16. The apparatus of claim 15, wherein the circuitry is further to:
limit access of the two or more model specific registers to software with a most trusted privilege level.

17. The apparatus of claim 15, wherein the circuitry is further to:
adjust how one or more prefetchers of the two or more prefetchers is trained at runtime based on information associated with the one or more prefetchers stored in the two or more model specific registers.

18. The apparatus of claim 15, wherein the circuitry is further to:
adjust a throttle of one or more prefetchers of the two or more prefetchers at runtime based on information associated with the one or more prefetchers stored in the two or more model specific registers.

19. The apparatus of claim 15, wherein the circuitry is further to:
adjust a filter of one or more prefetchers of the two or more prefetchers at runtime based on information associated with the one or more prefetchers stored in the two or more model specific registers.

20. The apparatus of claim 15, wherein the circuitry is further to:
adjust a threshold of one or more prefetchers of the two or more prefetchers at runtime based on information associated with the one or more prefetchers stored in the two or more model specific registers.

21. The apparatus of claim 20, wherein the circuitry is further to:
adjust an internal queue threshold of one or more prefetchers of the two or more prefetchers at runtime based on information associated with the one or more prefetchers stored in the two or more model specific registers.
